(19) United States
(12) Patent Application Publication
(10) Pub. No.: US 2007/0228762 A1
(43) Pub. Date: Oct. 4, 2007

(54) Instrument panel with exposed support structure and method of formation

(75) Inventors: Daniel R. Vander Sluis, Plymouth, MI (US); Yelena O. Gonopolskaya, Bloomfield, MI (US); John A. Vassallo, Allen Park, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/396,971

(22) Filed: Apr. 3, 2006

(51) Int. Cl. B62D 25/14

(52) U.S. Cl. 296/70

(57) ABSTRACT

An instrument panel for the passenger compartment of an automotive vehicle, including a support structure and a trim assembly. The trim assembly is disposed over a portion of the support structure so that a trim show portion and a support show portion cooperate to define an instrument panel show surface exposed to the passenger compartment.

### BACKGROUND

1. Field of the Invention

The invention relates generally to an instrument panel for the passenger compartment of an automotive vehicle. More specifically, the invention relates to an instrument panel having a support structure and a trim assembly cooperating to define a show portion exposed to the passenger compartment.

2. Related Technology

Instrument panels typically include a support structure, a trim assembly disposed over the support structure, and a plurality of instrument panel components supported by the trim assembly. The support structure extends across the width of the passenger compartment between vehicle frame pillars to enhance lateral strength of the vehicle and to support the trim assembly.

The trim assembly typically includes one or more “show” components made of aesthetically desirable materials, such as plastic, vinyl, leather, cloth, treated wood, or chrome, for supporting the instrument panel components and for providing a desired appearance. The trim assembly may also include an intermediate layer between the support structure and the show components for providing a desired feel or an impact-absorbing structure. For example, the intermediate layer may be a compressible foam so that the trim assembly has a soft-feel effect.

The instrument panel components are typically housed by openings or cavities formed in the trim assembly. These components typically include: outlet assemblies for HVAC units such as vent registers; human-machine interfaces such as audio system interfaces or HVAC interfaces; display components such as instrument gauges and clocks; and storage features such as cup holders and utility compartments.

However, disposing the trim assembly over the entire support structure may increase the part cost and/or the overall complexity of the instrument panel. Furthermore, providing trim between the support structure and the instrument panel components likewise increases the part cost and/or the overall complexity of the instrument panel.

Instrument panels also preferably include a desirable aesthetic appearance for the vehicle occupant. Unique features, such as highly-finished and/or stylized metal components, are often connected to the trim assembly of current instrument panels for such aesthetic purposes. However, such a configuration may further increase the part cost and/or manufacturing steps for producing the instrument panel.

It is therefore desirous to provide an instrument panel that provides the required lateral support while reducing the part cost and/or complexity and improving the overall aesthetics of the passenger compartment.

### SUMMARY

In overcoming the limitations and drawbacks of the prior art, the present invention provides an instrument panel for the passenger compartment of an automotive vehicle, including a support structure and a trim assembly cooperating to define an instrument panel show surface exposed to the passenger compartment. More specifically, the trim assembly is disposed over a portion of the support structure so that a trim show portion and a support show portion cooperate to define the instrument panel show surface.

In one aspect of the present invention, the instrument panel further includes an instrument panel component disposed in a recess defined by the support portion so that the trim support portion and the support show portion cooperate with a component show portion to define the instrument panel show surface. The instrument panel component is preferably one or more of the following: a human-machine interface, such as a heating ventilation and air conditioning unit interface or an entertainment system interface, a storage container, or an instrument display gauge. The support structure is preferably formed of a metal, such as magnesium alloy. Furthermore, the show portion of the support structure preferably includes a treatment coating. The support structure may be a single, unitary component or it may be a plurality of components integrally formed together.

In another aspect of the present invention, the support structure includes a longitudinal component extending in a longitudinal direction between the vehicle A-pillars to strengthen the instrument panel in the longitudinal direction and a transverse component extending generally perpendicularly to the longitudinal direction to strengthen the instrument panel in the transverse direction that is substantially perpendicular to the longitudinal direction. Additionally, a trim assembly is disposed over a portion of the support structure so that a trim show portion, a longitudinal component show portion, and a transverse component show portion cooperate with each other to define an instrument panel show surface exposed to the passenger compartment.

In yet another aspect of the present invention, a method of forming an instrument panel for a passenger compartment of an automotive vehicle is provided, including the steps of cast forming a support structure and disposing a trim assembly over a portion of the support structure so that a trim show portion and a support show portion cooperate to define an instrument panel show surface exposed to the passenger compartment.

The method also preferably includes the steps of providing a finishing treatment to the support structure show portion such as etching or applying a surface coating to resist corrosion and/or oxidation.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is an isometric view of an instrument panel for a passenger compartment of a motor vehicle embodying the principles of the present invention;

FIG. 2 is an isometric view of a support structure for an alternative embodiment of an instrument panel embodying the principles of the present invention;

FIG. 3 is an isometric view of the fully-assembled instrument panel having the support structure shown in FIG. 2; and

FIG. 4 is a flowchart showing a method of forming an instrument panel embodying the principles of the present invention.

### DETAILED DESCRIPTION

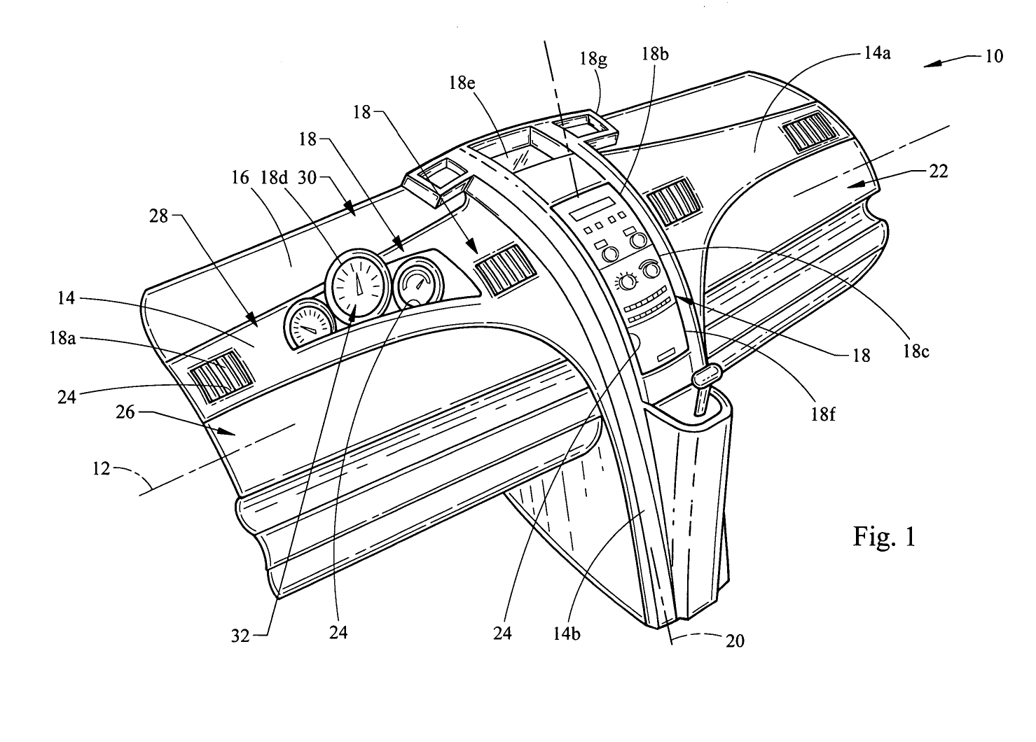

Referring now to the drawings, FIG. 1 shows an instrument panel 10 for use in a passenger compartment of a motor vehicle. The instrument panel generally extends across the width of the passenger compartment of the vehicle and supports various instrument panel components. The instrument panel 10 includes a support structure 14, a trim assembly 16 disposed over the support structure 14, and a plurality of instrument panel components 18.

More specifically, the support structure 14 includes a longitudinal component 14a extending generally in a longitudinal direction 12 between vehicle frame pillars (not shown) to enhance lateral strength of the vehicle. Additionally, the support structure 14 includes a transverse component 14b extending in an upright direction 20 that is generally perpendicular to the longitudinal direction 12 so as to vertically support the instrument panel 10 and to divide the passenger compartment into respective driver and passenger sides. The support structure 14 is preferably a single, unitary metal component made of an appropriate material, one such material being magnesium alloy. In an alternative embodiment, the support structure 14 is formed of another appropriate material such as a composite material, as will be discussed in more detail below. In yet another alternative embodiment, the support structure 14 may be formed of multiple components connected to each other, as will also be discussed in more detail below.

The trim assembly 16 is disposed over a portion of the support structure 14 for aesthetic and functional purposes. The trim assembly 16 is attached to the support structure 14 by any appropriate means, such as fasteners, clips mounting structures, adhesives, or snap fit connection. Alternatively, the trim assembly 16 may be attached to the support structure 14 during the formation of the trim assembly 16. For example, the support structure 14 may be inserted into a mold so that a molten material can be injected into the mold to define the trim assembly 16.

The trim assembly 16 includes an exposed portion composed of an aesthetically pleasing material, such as plastic, vinyl, leather, cloth, treated wood, or chrome to improve the overall appearance of the instrument panel 10. Additionally, the trim assembly 16 preferably includes impact zones 22 configured to absorb energy from an occupant during an impact event and therefore lower the occupant's deceleration when contacting the instrument assembly 10. The impact zones 22 may be completely made of a generally pliable material, such as thermoplastic, that deforms upon application of a predetermined force. Alternatively, the impact zones 22 may include a generally rigid outer layer for surface durability and a pliable intermediate or under layer for energy absorption.

As mentioned above, the instrument panel 10 includes a plurality of instrument panel components 18 such as: vent registers 18a for HVAC units; human-machine interfaces such as audio system interfaces 18b or HVAC interfaces 18c; display components such as instrument gauges 18d and clocks; and storage features such as cup holders (not shown), a utility compartment 18e for open storage of various articles, a storage bin 18f for closed storage of various articles, and utility restraints 18g that may serve as a tie-down connection point for the articles stored in the utility compartment 18e. However, any type of component that may be supported by the instrument panel 10 can be used in conjunction with the present invention. The components 18 in FIG. 1 area each disposed in a recess 24 of the support structure 14. More specifically, each recess 24 is a depression formed in or an opening formed through the support structure 14 having dimensions generally equal to the corresponding component 18 for a form-fit connection therebetween. Additionally or alternatively to the form-fitting connection, the components 18 may be secured to the metal support structure 14 via an appropriate connection such as adhesive, fasteners, clips and mounting structures.

The direct connection between the components 18 and the support structure 14 avoids the need for trim material therebetween, thereby reducing the overall complexity of the instrument panel 10 and reducing part costs. However, to reduce machining costs and improve the replaceability of the components 18, at least some of the components 18 are preferably not defined by the support structure 18. For example, the vent registers 18a shown in FIG. 1 are each secured within the recess 24 rather than being defined by the support structure 14. However, other components, such as the utility component 18e and the utility restraint 18g are defined by the support structure 14.

Although the support structure 14 shown in FIG. 1 is composed of a magnesium alloy, any other material having a sufficiently high modulus of elasticity to provide support for the instrument panel 10 may be used. For example, any material having a modulus of elasticity greater than or equal to 10 GPa is typically sufficiently stiff to provide such support, depending on their thickness and location within the instrument panel 10. However, materials with a higher modulus of elasticity, such as 40 GPa, may be even more desirable.

In another alternative design, the support structure 14 may be composed of two or more components that are integrally connected together to define the support structure 14. For example, the portion of the support structure 14 defining the utility compartment 18e and utility restraints 18g may be a first component and the remainder of the support structure 14 may be a second component. This design may be particularly advantageous for reducing part costs for the support structure 14. For example, the exposed portions of the support structure 14 can be formed of an aesthetically desirable material, such as magnesium alloy, while the non-exposed portions of the support structure 14 can be formed of a material having a lower part cost, such as steel.

The support structure 14, the trim assembly 16, and the components 18 cooperate to define a show surface 26 of the instrument panel 10 that is exposed to the occupants of the passenger compartment. More specifically, the support structure 14, the trim assembly 16, and the components 18 respectively define a support show portion 28, a trim show portion 30, and a component show portion 32 that cooperate to define the show surface 26. As a product of being exposed to the passenger compartment, it is desirable for the support show portion 28 to have a highly finished and/or stylized surface that is aesthetically pleasing and generally free of sharp exposed edges.

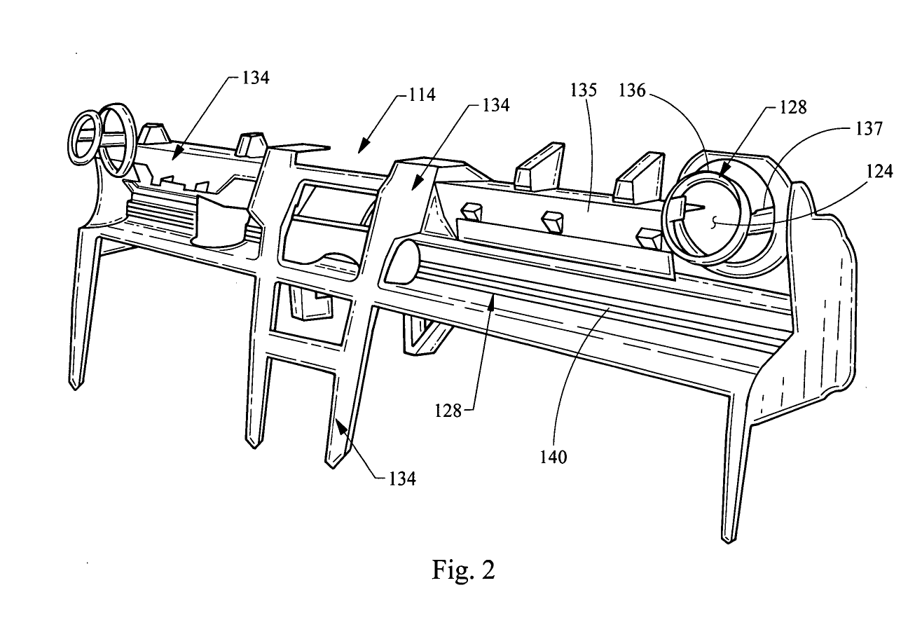

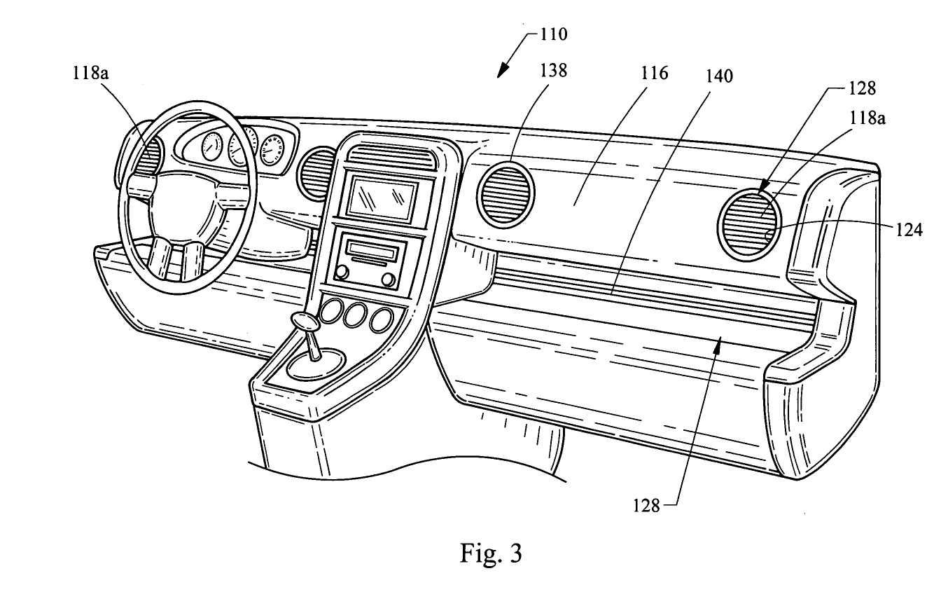

FIGS. 2 and 3 show an alternative embodiment of the present invention. More specifically, FIG. 2 depicts a support structure 114 before being coupled with a trim assembly and components so that support show or A-portions 128 and unseen support or B-portions 134 are both shown for illustrative purposes. FIG. 3 depicts a fully assembled instrument panel 110. The support structure 114 includes support show portions 128 defining recesses 124 for supporting vent registers 118a as in the embodiment shown in FIG. 1.

More specifically, the support show portions 128 include bezels 136 defining the recesses 124. The support structure 114 shown in FIGS. 2 and 3 is a single, unitary component. However, in an alternative design the bezels 136 or other portions of the support structure 114 may be separately formed and then coupled by any suitable means, such as welding or fastening respective portions together. In the illustrated embodiment, the bezels 136 are connected to the body 135 of the support structure 114 by break-away tabs 137 for safety purposes. The tabs 137 are designed to break and/or bend upon application of a sufficient force so as to limit the potential impact forces acting on the occupant during an impact event.

While four vent registers 118a are shown in FIG. 3, only two of the four are disposed within recesses of the support structure 114. The other two vent registers are each surrounded by decorative metal sleeves 138 that are disposed in recesses of the trim assembly 116. The sleeves are constructed so that they match with the bezels 136 of the other two vent registers.

The remaining components, such as the human-machine interfaces and the display components, are likewise disposed in and visible through recesses defined in the trim assembly 116, rather than in the support structure 114. It is therefore seen that the present invention may be used with an instrument panel having components supported by the trim assembly as well as the support structure 114.

The show portion 128 of the support structure 114 includes a stylized portion 140 for aesthetic purposes. More specifically, the stylized portion 140 in the figures includes a plurality of parallel ribs extending along the support show portion 128. Although the ribs are primarily provided for aesthetic purposes, they may also have a functional purpose, such as strengthening the support structure 114. The ribs are preferably unitarily formed in the support show portion 128 by an appropriate manufacturing process.

The support structures shown in the figures are preferably cast formed. More specifically, the support structures are preferably formed via die casting in a closed mold having a mold pressure greater than or equal to 10 megapascals (MPa). Alternatively, the support structure may be formed by open mold casting or by any other appropriate process, such as thermal forming or compression forming.

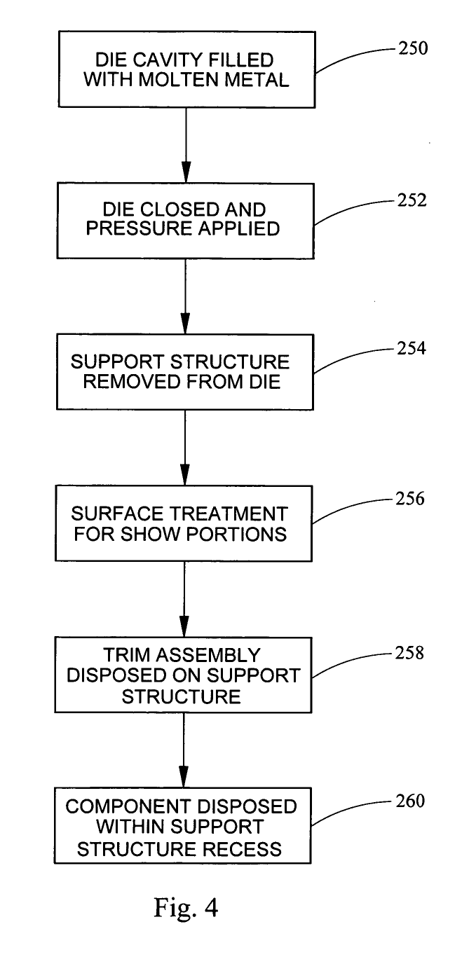

The flowchart of FIG. 4 depicts a method of forming an instrument panel embodying the principles of the present invention. First, in step 250, a die cavity defining the shape of a support structure is filled with molten metal. Then, in step 252, the die is closed and a pressure is applied to the molten material. However, the method may also be used with an open die utilizing gravitational forces to fully distribute the molten metal. Next, in step 254, the support structure is removed from the die after hardening and cooling. Although any suitable molten metal may be used, magnesium alloys may harden more quickly and conform to the cast surfaces more effectively than other suitable metals such as aluminum.

In step 256 the support show portions undergo surface treatment, such as acid etching or receiving a protective coating, to resist corrosion and/or oxidation. Additionally or alternatively, the support show portions may be undergo more extensive surface treatment, such as buffing, polishing, or machining stylized features into the surface, to enhance its aesthetics.

Next, in step 258 a trim assembly is disposed over a portion of the metal support structure so that a trim show portion and a support show portion cooperate to define an instrument panel show surface exposed to the passenger compartment. Finally, in step 260, an instrument panel component is disposed within a recess formed by the support structure.

In an alternative method of manufacturing, the support structure is formed by an alternative material, such as a composite material having an appropriate modulus of elasticity. In this design, the support structure may be formed by any appropriate method, such as injection molding or composite molding. Additionally, in a design where the support structure is formed of multiple components, the components may be coupled with each other via a molding process. For example, one of the components may be formed via a first step and then inserted into a mold, where it is coupled with a second component during the formation of the second component.

It is therefore intended that the foregoing detailed description be regarded as illustrative rather than limiting, and that it be understood that it is the following claims, including all equivalents, that are intended to define the spirit and scope of this invention.

What is claimed is:

1. An instrument panel for a passenger compartment of an automotive vehicle, the instrument panel having a cross-vehicle length and comprising:
a support structure extending substantially the full cross-vehicle length of the instrument panel to strengthen the instrument panel, the support structure having a support show portion defining at least one recess;
an instrument panel component disposed in the at least one recess; and
a trim assembly disposed over the non-show portion of the support structure, the trim assembly including a show surface cooperating with the support show portion to define an instrument panel show surface exposed to the passenger compartment.

2. An instrument panel as in claim 1, wherein the instrument panel component is an outlet assembly for a heating ventilation and air conditioning unit.

3. An instrument panel as in claim 2, wherein the outlet assembly is a vent register.

4. An instrument panel as in claim 1, wherein the instrument panel component is a human-machine interface.

5. An instrument panel as in claim 4, wherein the human-machine interface is a heating ventilation and air conditioning unit interface.

6. An instrument panel as in claim 4, wherein the human-machine interface is an entertainment system interface.

7. An instrument panel as in claim 6, wherein the entertainment system interface is an audio system interface.

8. An instrument panel as in claim 1, wherein the instrument panel component is a storage container.

9. An instrument panel as in claim 1, wherein the instrument panel component is an instrument display gauge.

10. An instrument panel as in claim 1, wherein the support structure is at least substantially formed of a metal.

11. An instrument panel as in claim 10, wherein the support structure is at least substantially formed of a magnesium alloy.

12. An instrument panel as in claim 1, wherein the support structure is at least substantially formed of a composite material.

13. An instrument panel as in claim 1, wherein the support show portion includes a treatment coating.

14. An instrument panel as in claim 1, wherein the support structure is a single, unitary component.

15. An instrument panel as in claim 1, wherein the support structure is formed from a plurality of components.

16. An instrument panel for a passenger compartment of an automotive vehicle, the instrument panel having a cross-vehicle length and comprising:
a support structure having a longitudinal component extending substantially the full cross-vehicle length of the instrument panel and a transverse component extending generally perpendicularly from the longitudinal component, the support structure having a support show portion and a non-show portion, where the support show portion is defined by the longitudinal component and the transverse component; and
a trim assembly disposed over the non-show portion of the support structure, the trim assembly including a show surface cooperating with the trim show portion to define an instrument panel show surface exposed to the passenger compartment.

17. An instrument panel as in claim 16, wherein the support structure is at least substantially formed of a magnesium alloy.

18. An instrument panel as in claim 16, wherein the support structure is formed from a plurality of components.

19. A method of forming an instrument panel for a passenger compartment of an automotive vehicle, comprising:
cast forming a support structure to extend substantially along a length of the instrument panel in a longitudinal direction and substantially strengthen the instrument panel in the longitudinal direction; and
disposing a trim assembly over a portion of the support structure so that a trim show portion and a support show portion cooperate to define an instrument panel show surface exposed to the passenger compartment.

20. A method as in claim 19, wherein the step of cast forming the support structure includes die cast forming the support structure.

21. A method as in claim 19, further comprising providing a finishing treatment to the support show portion.

22. A method as in claim 21, wherein the finishing treatment includes acid etching the support show portion.

23. A method as in claim 21, wherein the finishing treatment includes applying a protective coating to the support show portion.

24. A method as in claim 19, further comprising disposing an instrument panel component within a recess formed by the support structure.
